(19) United States
(12) Patent Application Publication
(10) Pub. No.: US 2026/0146184 A1
(43) Pub. Date: May 28, 2026

(54) COLORFUL TPU FILM CAPABLE OF BEING HOT-CUT AND PREPARATION METHOD THEREOF

(71) Applicant: GUANGDONG ZHONGDING TECHNOLOGY DEVELOPMENT CO., LTD., Dongguan City (CN)

(72) Inventor: Feng LI, Dongguan City (CN)

(73) Assignee: GUANGDONG ZHONGDING TECHNOLOGY DEVELOPMENT CO., LTD., Dongguan City (CN)

(21) Appl. No.: 18/956,561

(22) Filed: Nov. 22, 2024

(51) Int. Cl. C09J 7/35; C09J 7/25; C09J 11/04; C09J 11/06

(52) U.S. Cl. CPC C09J 7/35; C09J 7/25; C09J 11/04; C09J 11/06; C09J 2301/304; C09J 2301/408; C09J 2475/006

(57) ABSTRACT

A colorful TPU film capable of being hot-cut is provided, relating to the field of TPU technology. The colorful TPU film capable of being hot-cut includes a colorful layer and a TPU carrier layer arranged in sequence from top to bottom, the colorful layer includes raw materials in parts by weight: 45-55 parts of polyurethane pigment composite, 10-15 parts of epoxy resin, 13-17 parts of styrene-acrylic emulsion, 2-3 parts of sodium dodecyl sulfate, 5-6 parts of octylphenol polyoxyethylene ether, 1-2 parts of sodium bicarbonate, and 1-2 parts of potassium persulfate. The colorful TPU film capable of being hot-cut has strong tensile strength and adhesion, while the ability to be cut at high temperatures, making practical. The preparation method of the colorful TPU film capable of being hot-cut TPU film is easy to control, resulting the colorful TPU film capable of being hot-cut has stable quality and excellent comprehensive performance.

### FIELD

This application relates to the technical field of TPU technology, in particular to a colorful TPU film capable of being hot-cut and a preparation method thereof.

### BACKGROUND

At present, TPU films have found widespread applications due to their softness, excellent elasticity, and superior mechanical properties. The TPU films are used in a variety of products such as clothing, luggage, tents, shoe materials, and other fabrics. However, the TPU films available in prior art are often too simple in composition with lack visual appeal, and have average mechanical properties, failing to meet the demands of consumers. Additionally, the pigments in the films tend to melt and bleed during the thermal cutting process, causing inconvenience.

### SUMMARY

In order to overcome the shortcomings and deficiencies in the prior art, the purpose of the present disclosure is to provide a colorful TPU film capable of being hot-cut, having strong tensile strength and adhesion, while also featuring the ability to be cut at high temperatures, making highly practical.

A preparation method of the colorful TPU film capable of being hot-cut of the present disclosure is simple in process and easy to control in operation, which is conducive to industrial mass production, the resulting colorful TPU film capable of being hot-cut has stable quality, strong tensile strength, and strong adhesion, while also featuring the ability to be cut at high temperatures, and exhibiting superior overall performance.

The purpose of the present disclosure is achieved through the following technical solutions: the colorful TPU film capable of being hot-cut includes a colorful layer and a TPU carrier layer arranged in sequence from top to bottom, the colorful layer includes following raw materials in parts by weight: 45-55 parts of polyurethane pigment composite, 10-15 parts of epoxy resin, 13-17 parts of styrene-acrylic emulsion, 2-3 parts of sodium dodecyl sulfate, 5-6 parts of octylphenol polyoxyethylene ether, 1-2 parts of sodium bicarbonate, and 1-2 parts of potassium persulfate.

The colorful TPU film capable of being hot-cut of the present disclosure includes the colorful layer and the TPU carrier layer arranged in sequence from top to bottom, the colorful layer has strong tensile strength and strong adhesion, and also features an ability to be cut at high temperatures, the TPU carrier layer adopts TPU high and low temperature film, two sides of the TPU high and low temperature film have different melting points, primarily including a high-temperature layer with a higher melting point and a low-temperature layer with a lower melting point, the low-temperature layer is mainly used for bonding with other materials, while the high-temperature layer can serve as a carrier or surface layer, applied to the product surface to enhance properties such as corrosion resistance, impact resistance, and wear resistance, providing protective functions, the structure is simple to use.

In the above technical solutions, the polyurethane pigment composite includes Pigment Red 31, polydiallyldimethylammonium chloride, nano titanium dioxide sol, and polyurethane emulsion.

In the above technical solutions, a preparation method of the polyurethane emulsion includes the following steps:
(1) adding diol in a reaction vessel, stirring and heating to 115-130° C., with a pressure in the reaction vessel controlled at −0.02 to −0.06 MPa, for dehydration; then, filling nitrogen gas and cooling down temperature to 75-85° C., adding isophorone diisocyanate, dimethylolpropionic acid, and catalyst, after 1-3 hours of catalytic reaction, cooling down temperature to 65-75° C., and adding 2-(3-pyridyl)-1-hydroxyethane-1,1-diphosphonic acid, and continuing the reaction for 1-2 hours upon completion of the reaction to obtain Mixture Ao;
(2) cooling down to room temperature, adding triethylamine to adjust to neutrality, and then adding water for emulsification, resulting in the polyurethane emulsion.

In the above technical solutions, a molar ratio of the diol, 2-(3-pyridyl)-1-hydroxyethane-1,1-diphosphonic acid, dimethylolpropionic acid, and isophorone diisocyanate is 0.8-1.2:0.3-0.6:0.4-0.7:1.

In the above technical solutions, the catalyst includes at least one of dibutyltin dilaurate or stannous octoate; an added amount of the catalyst is 2-3% of a total mass of the diol and isophorone diisocyanate.

In the above technical solutions, the diol includes at least one of polytetrahydrofuran ether glycol, polyethylene glycol, and polycaprolactone diol.

In the above technical solutions, a preparation method of the nano titanium dioxide sol includes: dissolving 50-100 g of butyl titanate in 1 L of anhydrous acetaldehyde, adding 1-2 g of acetylacetone, under strong stirring, slowly adding a mixed solution of 0.1-0.5 mol/L nitric acid, deionized water, and anhydrous ethanol, resulting in a white gel-like precipitate appears, obtaining the nano titanium dioxide sol.

In the above technical solutions, a molar ratio of the nitric acid, the deionized water, and the anhydrous ethanol is 1:0.2:0.3.

In the above technical solutions, a preparation method of the polyurethane pigment composite includes:
(1) adding the polydiallyldimethylammonium chloride to Pigment Red 31, ultrasonically dispersing for 15-30 minutes, then settling and centrifuging to separate a first precipitate, performing ultrasonic washing on the first precipitate to obtain Mixture A;
(2) adding polyurethane emulsion to the Mixture A, ultrasonically dispersing for 15-30 minutes, then settling and centrifuging to separate a second precipitate, performing ultrasonic washing on the second precipitate to obtain Mixture B;
(3) adding the nano titanium dioxide sol to the Mixture B, ultrasonically dispersing for 15-30 minutes, then settling and centrifuging to separate a third precipitate performing ultrasonic washing on the third precipitate to obtain Mixture C;
(4) adding polyurethane emulsion to the Mixture C, ultrasonically dispersing for 15-30 minutes, then settling and centrifuging to separate a fourth precipitate, performing ultrasonic washing on the forth precipitate to obtain the polyurethane pigment composite.

In the above technical solutions, in the preparation method of the polyurethane pigment composite, a molar ratio of polydiallyldimethylammonium chloride added in step (1) to Pigment Red 31 is 1.8-2.2:1; a molar ratio of polyurethane emulsion added in step (2) to the polydiallyldimethylammonium chloride added in step 1 is 1.5-1.7:1; a molar ratio of nano titanium dioxide sol added in step (3) to the polyurethane emulsion added in step (2) is 1.8-2.2:1; a molar ratio of polyurethane emulsion added in step (4) to the nano titanium dioxide sol added in step (3) is 0.8-1.2:1.

The preparation method of the colorful TPU film capable of being hot-cut film includes the following steps:
(S1) mixing the polyurethane pigment composite, sodium dodecyl sulfate, octylphenol polyoxyethylene ether, sodium bicarbonate, epoxy resin, styrene-acrylic emulsion, and potassium persulfate evenly, heating to 75-80° C., and reacting at 75-80° C. for 2-3 hours, cooling down to 35-45° C., filtering to obtain polymer emulsion;
(S2) at room temperature, coating the polymer emulsion on an upper end surface of the TPU carrier layer, settling for 5-10 minutes, reacting in an oven at 90-110° C. for 1-2 hours, forming a colorful layer to obtain an intermediate product;
(S3) putting the intermediate product on a heating plate at 75-90° C., treating with steam for 2-3 minutes, then stopping the steam treatment, heating for 8-12 minutes, slowly cooling down to room temperature to obtain the colorful TPU film capable of being hot-cut

In the above technical solutions, a thickness of the colorful layer is 10-14 μm, and a thickness of the TPU carrier layer is 0.5-1 mm.

The preparation method of the colorful TPU film capable of being hot-cut of the present disclosure has a simple process and is easy to control in operation, which is conducive to industrial mass production. The resulting TPU film has stable quality, strong tensile strength and strong adhesion, while also featuring the ability to be cut at high temperatures, and exhibiting excellent comprehensive performance.

The beneficial effects of the present disclosure are as follows: the colorful TPU film capable of being hot-cut of the present disclosure includes an colorful layer and a TPU carrier layer arranged sequentially from top to bottom, the TPU carrier layer adopts a TPU high and low temperature film, which has different melting points on each of two sides, primarily including a high-temperature layer with a higher melting point and a low-temperature layer with a lower melting point, the low-temperature layer is mainly used for bonding with other materials, while the high-temperature layer can serve as a carrier or surface layer, applied to the product surface to enhance properties such as corrosion resistance, impact resistance, and wear resistance, providing protective functions. The structure is simple and convenient to use.

The colorful TPU film capable of being hot-cut of the present disclosure has strong tensile strength and strong adhesion, while also featuring an ability to be cut at high temperatures. The TPU film has a simple structure, is easy to use, and is highly practical.

At the same time, the preparation method of the colorful TPU film capable of being hot-cut is simple in process and easy to control, which is conducive to industrial mass production, the resulting colorful TPU film capable of being hot-cut has stable quality, strong tensile strength, and strong adhesion, while also featuring the ability to be cut at high temperatures, and exhibiting excellent comprehensive performance.

### DETAILED DESCRIPTION OF EMBODIMENTS

In order to facilitate the understanding for those skilled in the art, the present disclosure is further described below in conjunction with embodiments, and the solutions mentioned in embodiments are not intended to limit the present disclosure.

### Embodiment 1

In the embodiment, a colorful TPU film capable of being hot-cut includes a colorful layer and a TPU carrier layer arranged in sequence from top to bottom. The colorful layer includes the following raw materials in parts by weight: 50 parts of polyurethane pigment composite, 12 parts of epoxy resin, 15 parts of styrene-acrylic emulsion, 2 parts of sodium dodecyl sulfate, 5 parts of octylphenol ethoxylate, 1 part of sodium bicarbonate, and 2 parts of potassium persulfate.

In the embodiment, the epoxy resin used was a bisphenol A-type epoxy resin with an epoxy value of 0.46 from Shanghai Loho High-Tech Materials Co., Ltd; the styrene-acrylic emulsion used was LCN 070 from Clariant Chemicals. The Octylphenol ethoxylate used was OP-15 from Hai Shi Chemical.

In the embodiment, the TPU carrier layer was a transparent TPU film with a model number ZD-135 CM*85A from Guangdong Zhongding Technology Development Co., Ltd., and a thickness was 0.6 mm.

Furthermore, the polyurethane pigment composite includes Pigment Red 31, polydiallyldimethylammonium chloride, nano titanium dioxide sol, and polyurethane emulsion.

In the embodiment, the polydiallyldimethylammonium chloride used was CAS number 26062-79-3 from Shanghai Pande.

Furthermore, a preparation method of the polyurethane emulsion included the following steps:
(1) Diol was placed in a reaction vessel, stirred and heated to 120° C., a pressure in the reaction vessel was controlled at −0.04 MPa for dehydration; then, nitrogen gas was filled, a temperature was cooled down to 80° C.; isophorone diisocyanate, dimethylolpropionic acid, and catalyst were added, after 1.5 hours of catalytic reaction, the temperature was cooled down to 65° C.; 2-(3-pyridyl)-1-hydroxyethane-1,1-diphosphonic acid were added, the reaction continued for 1-2 hours, Mixture Ao was obtained upon completion of the reaction.
(2) The system temperature was cooled down to room temperature, triethylamine was added to adjust to neutrality, and then water was added for emulsification to obtain the polyurethane emulsion.

Furthermore, a molar ratio of the diol, 2-(3-pyridyl)-1-hydroxyethane-1, 1-diphosphonic acid, dimethylolpropionic acid, and isophorone diisocyanate was 1:0.4:0.6:1.

Furthermore, the added amount of the catalyst was 2% of a total mass of the diol and isophorone diisocyanate.

In the embodiment, the polycaprolactone diol used was PCL-1000.

Furthermore, a preparation method of the nano titanium dioxide sol was as follows: 80 g of butyl titanate was dissolved in 1 L of anhydrous acetaldehyde, 1 g of acetylacetone was added, under strong stirring, dropped into a mixed solution of 0.3 mol/L nitric acid, deionized water, and anhydrous ethanol, a white gel-like precipitate appeared, to obtain the nano titanium dioxide sol.

Furthermore, a molar ratio of the nitric acid, the deionized water, and the anhydrous ethanol was 1:0.2:0.3.

Furthermore, a preparation method of the polyurethane pigment composite included:
(1) The polydiallyldimethylammonium chloride was added to the Pigment Red 31, ultrasonically dispersed for 20 minutes, then settled and centrifuged to separate, ultrasonic washing was performed to obtain Mixture A;
(2) The polyurethane emulsion was added to Mixture A, ultrasonically dispersed for 20 minutes, then settled and centrifuged to separate, ultrasonic washing was performed to obtain Mixture B;
(3) The nano titanium dioxide sol was added to Mixture B, ultrasonically dispersed for 20 minutes, then settled and centrifuged to separate; ultrasonic washing was performed to obtain Mixture C;
(4) The polyurethane emulsion was added to Mixture C, ultrasonically dispersed for 20 minutes, then settled and centrifuged to separate, ultrasonic washing was performed to obtain the polyurethane pigment composite.

Furthermore, in the preparation method of the polyurethane pigment composite, a molar ratio of polydiallyldimethylammonium chloride added in step (1) to Pigment Red 31 was 2:1; a molar ratio of polyurethane emulsion added in step (2) to the polydiallyldimethylammonium chloride added in step (1) was 1.6:1; a molar ratio of nano titanium dioxide sol added in step (3) to the polyurethane emulsion added in step (2) was 1.9:1; and a molar ratio of the polyurethane emulsion added in step (4) to the nano titanium dioxide sol added in step (3) was 0.9:1.

A preparation method of the colorful TPU film capable of being hot-cut included the following steps:
(S1) The polyurethane pigment composite, sodium dodecyl sulfate, octylphenol polyoxyethylene ether, sodium bicarbonate, epoxy resin, styrene-acrylic emulsion, and potassium persulfate were mixed evenly, heated to 80° C., and reacted at 80° C. for 1.5 hours, cooled down to 40° C., filtered to obtain the polymer emulsion;
(S2) At room temperature, the polymer emulsion was evenly coated on an upper end surface of the TPU carrier layer, settled for 8 minutes, then reacted in an oven at 100° C. for 1.5 hours, the colorful layer was formed to obtain an intermediate product;
(S3) The intermediate product was placed on a heating plate at 85° C., treated with steam for 1 minute, then the steam treatment was stopped, continued heated for 10 minutes, slowly cooled down to room temperature to obtain the colorful TPU film capable of being hot-cut.

In the embodiment, a thickness of the colorful layer was 12 μm.

### Embodiment 2

In the embodiment, the preparation method of the polyurethane emulsion included the following steps:
(1) The diol was placed in a reaction vessel, stirred and heated to 120° C., the pressure in the reaction vessel was controlled at −0.04 MPa, for dehydration; then, the nitrogen gas was filled, the temperature was cooled down to 80° C., the isophorone diisocyanate, the dimethylolpropionic acid, and the catalyst were added, after 1.5 hours of catalytic reaction, cooled down to 65° C., and the 2-(3-pyridyl)-1-hydroxyethane-1, 1-diphosphonic acid was added, the reaction continued for 1-2 hours, Mixture Ao was obtained upon completion of the reaction.
(2) The system temperature was cooled down to room temperature, triethylamine was added to adjust to neutrality, and then the water was added for emulsification to obtain the polyurethane emulsion.

In the embodiment, the polyethylene glycol was polyethylene glycol 1000.

Furthermore, a molar ratio of the polyethylene glycol, 2-(3-pyridyl)-1-hydroxyethane-1, 1-bisphosphonic acid, dimethylolpropionic acid, and isophorone diisocyanate was 1:0.4:0.6:1.

Furthermore, the catalyst was the dibutyltin dilaurate; the added amount of the catalyst was 2% of the total mass of the diol and isophorone diisocyanate.

The preparation method of the colorful TPU film capable of being hot-cut includes the following steps:
(S1) The polyurethane pigment composite, sodium dodecyl sulfate, octylphenol polyoxyethylene ether, sodium bicarbonate, epoxy resin, styrene-acrylic emulsion, and potassium persulfate were mixed evenly, heated to 80° C., and reacted at 80° C. for 1.3 hours, cooled down to 40° C., filtered to obtain the polymer emulsion;
(S2) At room temperature, the polymer emulsion was evenly coated on an upper end surface of the TPU carrier layer, settled for 8 minutes, then reacted in an oven at 100° C. for 1.5 hours, the colorful layer was formed to obtain the intermediate product;
(S3) The intermediate product was placed on a heating plate at 85° C., treated with the steam for 1 minute, then the steam treatment was stopped, continued heating for 10 minutes, slowly cooled down to room temperature to obtain the colorful TPU film capable of being hot-cut.

The rest of the embodiment was the same as that of Embodiment 1.

### Embodiment 3

In the embodiment, the preparation method of the polyurethane emulsion included the following steps:
(1) The diol was placed in a reaction vessel, stirred and heated to 120° C., the pressure in the reaction vessel was controlled at −0.04 MPa, for dehydration; then, the nitrogen gas was filled, cooled down to 80° C., the isophorone diisocyanate, dimethylolpropionic acid, and catalyst were added, after 1.5 hours of catalytic reaction, was cooled down to 65° C., and the 2-(3-pyridyl)-1-hydroxyethane-1,1-diphosphonic acid was added, the reaction continued for 1-2 hours, Mixture Ao was obtained upon completion of the reaction.
(2) The system temperature was cooled down to room temperature, the triethylamine was added to adjust to neutrality, and then the water was added for emulsification to obtain the polyurethane emulsion.

In the embodiment, the polytetrahydrofuran ether glycol was polytetrahydrofuran ether glycol 1000.

Furthermore, a molar ratio of the polytetrahydrofuran ether glycol, 2-(3-pyridyl)-1-hydroxyethane-1,1-bisphosphonic acid, dimethylolpropionic acid, and isophorone diisocyanate was 1:0.4:0.6:1.

Furthermore, the catalyst was the dibutyltin dilaurate; the added amount of the catalyst was 2% of the total mass of the diol and isophorone diisocyanate.

The preparation method of the colorful TPU film capable of being hot-cut included the following steps:
(S1) The polyurethane pigment composite, sodium dodecyl sulfate, octylphenol polyoxyethylene ether, sodium bicarbonate, epoxy resin, styrene-acrylic emulsion, and potassium persulfate were mixed evenly, heated to 80° C., and reacted at 80° C. for 1.6 hours, cooled down to 40° C., filtered to obtain the polymer emulsion;
(S2) At room temperature, the polymer emulsion was evenly coated on an upper end surface of the TPU carrier layer, settled for 8 minutes, then reacted, in an oven at 100° C. to react for 1.5 hours, the colorful layer was formed, to obtain the intermediate product;
(S3) The intermediate product was placed on a heating plate at 85° C., treated with the steam for 1 minute, then the steam treatment was stopped, continued heating for 10 minutes, slowly cooled down to room temperature to obtain the colorful TPU film capable of being hot-cut.

The rest of the embodiment was the same as that of Embodiment 1.

### Comparison 1

The difference between Comparison 1 and Embodiment 3 is that in the preparation method of the polyurethane composite, the polyurethane pigment composite is replaced with an equivalent amount of commercially available polyurethane PU color paste, the polyurethane PU color paste used is product number 1102 from Dongguan Yunze New Material Technology Co., Ltd.

In the comparison, the preparation method of the colorful TPU film capable of being hot-cut included the following steps:
(S1) The polyurethane pigment composite, sodium dodecyl sulfate, octylphenol polyoxyethylene ether, sodium bicarbonate, epoxy resin, styrene-acrylic emulsion, and potassium persulfate were mixed evenly, heated to 80° C., and reacted at 80° C. for 1.3 hours, cooled down to 40° C., filtered to obtain the polymer emulsion;
(S2) At room temperature, the polymer emulsion was evenly coated on an upper end surface of the TPU carrier layer, settled for 8 minutes, then reacted, in an oven at 100° C. to react for 1.5 hours, the colorful layer was formed, to obtain the intermediate product.

### Performance Testing Experiment

Performance tests were conducted on the colorful TPU film capable of being hot-cut prepared in Embodiments 1-3 and Comparison 1. The tests evaluate the tensile strength of the colorful TPU films, the adhesion of the colorful layer, and the cutting performance using a 260° C. hot cutting knife. The test data is shown in the following Table 1:

TABLE 1

| | Project | | | |
|---|---|---|---|---|
| | Embodi- | Embodi- | Embodi- | Compar- |
| | ment 1 | ment 2 | ment 3 | ison 1 |
| Adhesion | 3-4 Grades | 3-4 Grades | 4 Grades | 3 Grades |
| Tensile | 22.8 | 22.6 | 22.7 | 18.3 |
| Strength/MPA | | | | |
| Cross-section | Cross- | Cross- | Cross- | Cross- |
| | section | section | section | section |
| | is smooth, | is smooth, | is smooth, | is softened, |
| | no pigment | no pigment | no pigment | a small |
| | melting or | melting or | melting or | amount of |
| | bleeding | bleeding | bleeding | pigment |
| | | | | melting and |
| | | | | bleeding |

In this case, the adhesion test is conducted according to GB/T 9286-1998; the tensile strength test is performed according to GB/T 1040.3-2006, with a tensile rate of 100 mm/min.

The above embodiments are preferred implementations of the present disclosure, in addition, the present disclosure can be implemented in other ways, any obvious replacement that do not depart from the spirit of the disclosure are within the scope of protection of the present disclosure.

1-10. (canceled)

11. A colorful TPU film capable of being hot-cut, comprising: a colorful layer and a TPU carrier layer arranged in sequence from top to bottom, the colorful layer comprises raw materials in parts by weight as follows: 45-55 parts of polyurethane pigment composite, 10-15 parts of epoxy resin, 13-17 parts of styrene-acrylic emulsion, 2-3 parts of sodium dodecyl sulfate, 5-6 parts of octylphenol polyoxyethylene ether, 1-2 parts of sodium bicarbonate, and 1-2 parts of potassium persulfate.

12. The colorful TPU film capable of being hot-cut according to claim 11, wherein the polyurethane pigment composite comprises Pigment Red 31, polydiallyldimethylammonium chloride (PDADMAC), nano titanium dioxide sol, and polyurethane emulsion.

13. The colorful TPU film capable of being hot-cut according to claim 12, wherein a preparation method of the polyurethane emulsion comprises steps of: (1) adding diol in a reaction vessel, stirring and heating to 115-130° C., with a pressure in the reaction vessel controlled at −0.02 to −0.06 MPa, for dehydration; then, filling nitrogen gas and cooling down to 75-85° C., adding isophorone diisocyanate, dimethylolpropionic acid, and catalyst, after 1-3 hours of catalytic reaction, cooling down to 65-75° C., and adding 2-(3-pyridyl)-1-hydroxyethane-1,1-diphosphonic acid, and continuing the reaction for 1-2 hours upon completion of the reaction to obtain Mixture Ao; and (2) cooling down to room temperature, adding triethylamine to adjust to neutrality, and then adding water for emulsification to obtain the polyurethane emulsion.

14. The colorful TPU film capable of being hot-cut according to claim 13, wherein a molar ratio of the diol, 2-(3-pyridyl)-1-hydroxyethane-1,1-diphosphonic acid, dimethylolpropionic acid, and isophorone diisocyanate is 0.8-1.2:0.3-0.6:0.4-0.7:1.

15. The colorful TPU film capable of being hot-cut according to claim 13, wherein the catalyst comprises at least one of dibutyltin dilaurate or stannous octoate.

16. The colorful TPU film capable of being hot-cut according to claim 13, wherein an added amount of the catalyst is 2-3% of a total mass of the diol and the isophorone diisocyanate.

17. The colorful TPU film capable of being hot-cut according to claim 13, wherein the diol comprises at least one of polytetrahydrofuran ether glycol, polyethylene glycol, and polycaprolactone diol.

18. The colorful TPU film capable of being hot-cut according to claim 12, wherein a preparation method of the nano titanium dioxide sol comprises: dissolving 50-100 g of butyl titanate in 1 L of anhydrous acetaldehyde, adding 1-2 g of acetylacetone, under strong stirring, slowly adding a mixed solution of 0.1-0.5 mol/L nitric acid, deionized water, and anhydrous ethanol, resulting in a white gel-like precipitate appears, obtaining the nano titanium dioxide sol.

19. The colorful TPU film capable of being hot-cut according to claim 12, wherein a preparation method of the polyurethane pigment composite comprises: (1) adding the polydiallyldimethylammonium chloride to the Pigment Red 31, ultrasonically dispersing for 15-30 minutes, then settling and centrifuging to separate a first precipitate, performing ultrasonic washing on the first precipitate to obtain Mixture A; (2) adding the polyurethane emulsion to the Mixture A, ultrasonically dispersing for 15-30 minutes, then settling and centrifuging to separate a second precipitate, performing ultrasonic washing on the second precipitate to obtain Mixture B; (3) adding the nano titanium dioxide sol to the Mixture B, ultrasonically dispersing for 15-30 minutes, then settling and centrifuging to separate a third precipitate performing ultrasonic washing on the third precipitate to obtain Mixture C; and (4) adding the polyurethane emulsion to the Mixture C, ultrasonically dispersing for 15-30 minutes, then settling and centrifuging to separate a fourth precipitate, performing ultrasonic washing on the fourth precipitate to obtain the polyurethane pigment composite.

20. A preparation method of the colorful TPU film capable of being hot-cut according to claim 11, comprising: (S1) mixing the polyurethane pigment composite, sodium dodecyl sulfate, octylphenol polyoxyethylene ether, sodium bicarbonate, epoxy resin, styrene-acrylic emulsion, and potassium persulfate evenly, heating to 75-80° C., and reacting at 75-80° C. for 1-3 hours, cooling down to 35-45° C., filtering to obtain the polymer emulsion; (S2) at room temperature, coating the polymer emulsion on an upper end surface of the TPU carrier layer, settling for 5-10 minutes, reacting in an oven at 90-110° C. for 1-2 hours, forming the colorful layer to obtain an intermediate product; and (S3) putting the intermediate product on a heating plate at 75-90° C., treating with steam for 1-3 minutes, then stopping the steam treatment, heating for 8-12 minutes, slowly cooling down to room temperature to obtain the colorful TPU film capable of being hot-cut.
